(19) United States
(12) Patent Application Publication
(10) Pub. No.: US 2022/0107178 A1
(43) Pub. Date: Apr. 7, 2022

(54) Method and Apparatus for Determining a Layer Thickness of a Layer Applied to a Substrate

(71) Applicant: Stefan Böttger, St. Ingbert (DE)

(72) Inventor: Stefan Böttger, St. Ingbert (DE)

(21) Appl. No.: 17/429,631

(22) PCT Filed: Feb. 18, 2020
(86) PCT No.: PCT/EP2020/054186

§ 371 Date: Aug. 10, 2021

(30) Foreign Application Priority Data
Feb. 20, 2019 (DE) 10 2019 104 260.7

(51) Int. Cl. G01B 21/08; G01N 25/72

(52) U.S. Cl. CPC G01B 21/085; G01N 25/72

(57) ABSTRACT

A method for determining a layer thickness of a layer applied to a substrate, in particular a coating layer, in which at least one surface area of the coated substrate is heated by irradiation with at least one radiation source and/or inductively, and thermal radiation emitted from the at least one surface area is detected by a detection device. Expediently, the layer thickness is determined based on the emitted thermal radiation. The at least one surface area is irradiated by the at least one radiation source and heats up and/or is inductively heated. Heat radiation emitted from the surface area is characteristic for a certain layer thickness and is detected by the detection device and transmitted to the evaluation device. Furthermore, the invention relates to an apparatus for determining a layer thickness of a layer applied to a substrate.

### CROSS REFERENCE TO RELATED APPLICATIONS

This application is the U.S. national stage of International Application No. PCT/EP2020/054186, filed on 2020 Feb. 18. The international application claims the priority of DE 102019104260.7 filed on 2019 Feb. 20; all applications are incorporated by reference herein in their entirety.

### BACKGROUND

The invention relates to a method for determining a layer thickness of a layer applied to a substrate, in particular a coating layer, in which at least one surface area of the coated substrate is heated by irradiation with at least one radiation source and/or inductively heated, and thermal radiation emitted from the at least one surface area is detected by a detection device. Furthermore, the invention relates to an apparatus for determining a layer thickness of a layer applied to a substrate.

A method known as photothermics is known from prior art. A coated substrate is irradiated in a single area with a laser. The coating layer is heated and emits thermal radiation, in particular depending on a layer thickness and a coating material, which thermal radiation is detected by a detector. The emission of thermal radiation is time-delayed compared to the irradiation with a so-called phase shift Φ. By determining Φ of emitted thermal radiation, in particular its wavelength, as well as known calibration curves, the coating layer thickness can be determined.

### SUMMARY

The invention relates to a method for determining a layer thickness of a layer applied to a substrate (2-2g), in particular a coating layer, in which at least one surface area (7-7c; 22-25; 22e-25e; 27; 7g) of the coated substrate (2-2g) is heated by irradiation with at least one radiation source (5-5b; 5c, 19; 5d-g) and/or inductively, and thermal radiation emitted from the at least one surface area (7-7c; 22-25; 22e-25e; 27; 7g) is detected by a detection device (8-8g). Expediently, the layer thickness is determined based on the emitted thermal radiation. The at least one surface area is irradiated by the at least one radiation source and heats up and/or is inductively heated. Heat radiation emitted from the surface area is characteristic for a certain layer thickness and is detected by the detection device and transmitted to the evaluation device. By comparison of a detected heat radiation curve with a calibration curve, the evaluation device can determine the layer thickness and output a measured value. Furthermore, the invention relates to an apparatus for determining a layer thickness of a layer applied to a substrate.

### DETAILED DESCRIPTION

An object of the present invention is to develop a method of the type mentioned before, to enable for example a paint film thickness measurement on a bodywork component made of plastic for a motor vehicle or on a painted metallic housing for a mobile telephone.

According to the invention, the object is achieved in that the layer thickness is determined based on the emitted thermal radiation.

For the determination of the layer thickness, a surface to be measured can be completely recorded or divided into several surface areas to be measured individually, whose respective average surface area layer thicknesses can be combined to form a layer thickness profile of the surface. The at least one surface area is irradiated and heated by the at least one radiation source and/or is inductively heated. Thermal radiation emitted from the surface area is characteristic for a particular layer thickness and is detected by the detection device and transmitted to the evaluation device. By comparing a detected heat radiation curve and/or a parameter determined from the heat radiation curve, in particular the phase shift Φ, with a calibration curve, the evaluation device can determine the layer thickness and output a measured value or a layer thickness profile.

If heating is carried out by irradiation and inductively, a particularly good and rapid heating is advantageously achieved.

If heating takes place inductively, a determination of a coating layer thickness between 2 and 10 μm is particularly accurate.

It is expedient that the at least one surface area is irradiated with a monochromatic and/or coherent radiation source or with electromagnetic radiation of a specific wavelength range, preferably between 200 nm and 15 μm, in particular between 200 and 750 nm, between 800 and 3500 nm or between 4 and 13 μm. A radiation source can be designed, for example, as a laser, which has a wavelength between 200 and 1000 nm. It is also conceivable to use a CO₂ laser for a wavelength of 10.6 μm or a QCL laser (=quantum cascade laser) for a wavelength between 4 and 13 μm.

If electromagnetic radiation of a certain wavelength range is to be used, it is conceivable to use one or more light-emitting diodes (LEDs), in particular colored ones, for example blue ones. This is particularly advantageous if the coating layer of a protective cover or a housing for a cell phone is colored. Suitable selection of a radiation source results in particularly good absorption of the radiation and thus particularly good heating, which leads to a detectable emission of thermal radiation. The better the absorption, the better a measurement result is, on the basis of which the layer thickness is determined.

It is also conceivable that light-emitting diodes are used that emit in the ultraviolet or infrared wavelength range. The radiation source preferably has a wavelength or wavelength range in the near IR range, in particular between 800 and 1600 nm. The wavelength or wavelength range used to heat a coated substrate is not in the wavelength range visible to an operator. Advantageously, the device can have an open housing and can be operated without shielding or glare protection. Its design is thus simplified and a particularly safe workplace for a person operating the device is created.

Thermal radiators, for example radiant heaters, are also conceivable as a source of radiation.

In an embodiment of the method, the at least one surface area is irradiated with several identical or different radiation sources. Identical radiation sources emit identical wavelengths or identical wavelength ranges, while different radiation sources emit different wavelengths or wavelength ranges. Wavelength ranges are different from each other, if central wavelengths are different from each other. Advantageously, a particularly high power can be provided for heating.

It is also conceivable that a particularly large surface area, which can be several square centimeters or several square meters, is irradiated for the determination of the layer thickness.

Further advantageously, an existing measuring device can be supplemented by one or more, preferably different further radiation sources, in order to carry out a thickness measurement on a further, in particular different, coated substrate. For example, a thickness of a top coating layer applied to a railroad car can be determined by irradiation with light-emitting diodes, while a thickness of an underlying filler layer can be determined by irradiation with halogen lamps.

It is also conceivable that the multiple radiation sources are integrated into a single housing. These could be, for example, several different light emitting diodes (LED).

It is expedient to irradiate the at least one surface area with several radiation sources, each of which is designed to generate electromagnetic radiation of a specific wavelength range or a specific wavelength. If multiple, mutually different radiation sources are used, irradiation with a particularly broad wavelength range can be provided. For example, a red, a green and a blue LED can be used for irradiation, in particular simultaneously. Advantageously, in particular a layer thickness determination can be determined independently of a color of a layer to be measured. This allows flexible use of an apparatus for carrying out the method.

It is conceivable that the wavelength ranges of the multiple radiation sources do not have overlapping ranges.

It is also conceivable to use a superluminescent diode that emits electromagnetic radiation of a broad wavelength range with simultaneously high spatial coherence. Advantageously, a single radiation source can be sufficient to determine a layer thickness of differently colored layers with a single device.

In another embodiment of the invention, the irradiation of the at least one surface area is periodically modulated, in particular with a frequency between 0.01 and 2000 Hz, preferably between 20 to 800 Hz. Preferably, a temperature change of the surface area is detected for each period. By means of a periodic irradiation, a coating layer thickness value per period or a thickness of layer of a coating per period can be determined by an evaluation device. By averaging over all periods, a particularly accurate value for the layer thickness can be determined.

For a plastic substrate, a frequency of 10 to 800 Hz, preferably between 140 and 500 Hz, was found to be particularly advantageous.

To determine a coating layer thickness of a powder-coated substrate, frequencies between 0.5 and 10 Hz are advantageous, while coating layer thickness measurements on metallic motor vehicle components or motor vehicle bodies require frequencies between 2 and 120 Hz. In particular, the method according to the invention is very good at determining a thickness of a powder layer applied to an electrodeposition coating (ETL), for example.

If a thickness of a layer applied to a coil is to be determined, frequencies between 5 and 500 Hz are advantageous.

In a further embodiment of the invention, the irradiation of the at least one surface area is performed once by a light pulse. Advantageously, a high surface power is possible. Such a light pulse preferably has a wavelength or a wavelength range in the infrared range (IR) and can be generated by a pulse radiation source.

In an embodiment of the invention, several, preferably adjacent surface areas are successively irradiated by the at least one radiation source and by means of an evaluation device, a preferably graphically displayable layer thickness profile of a surface to be measured is established. In this way, a surface of large substrates can be divided into several smaller surface areas, which are successively heated and measured in order to determine a layer thickness profile for the entire surface. It is also conceivable that a single surface area corresponds to the entire surface to be measured.

A graphically displayable coating thickness profile can, for example, be shown directly to an operator on a display screen. By suitable selection of layer thickness limits, it can be immediately displayed whether these limits are exceeded or not reached at some points. This enables a simple quality control. Faultily coated substrates can be sorted out.

In a particular embodiment of the invention, all surface areas that together form a total surface are irradiated successively or simultaneously with the at least one radiation source in a pulse-like or periodically modulated manner. If the irradiation is periodically modulated, continuous measurement and continuous measurement data acquisition are possible. It is possible to use an apparatus according to the invention in a continuous process, for example for measuring the thickness of a coating layer in automobile production or in the fabrication of coated coils or foils.

For quality control of large-area coated components, for example painted bumpers for a motor vehicle, it is conceivable that the at least one radiation source, a device for inductive heating and/or the detection device is or are movable and is or are preferably attached to an industrial robot. This makes it possible to move past the component. An existing production line can advantageously be supplemented by the apparatus to carry out the method.

It is expedient that the at least one surface area has a size, in particular a diameter, between 0.2 μm and 200 cm, preferably between 1 and 20 μm or between 0.2 and 2 cm. The smaller the substrate to be examined, the smaller a surface area to be examined can be. For example, in a protective cover or in a housing for a cell phone, a surface area may comprise the entire surface facing a radiation source or may be between 1 and 2 μm in size, while in a coated bumper for a motor vehicle, a surface area may correspond to the entire surface facing a radiation source or may be between 0.5 mm and 2 cm in size.

In an embodiment of the invention, the at least one surface area is irradiated obliquely or parallel to a surface normal. While an interferometric measurement of a surface for the determination of its, for example, optical properties, requires an irradiation parallel to a surface normal, this is not necessary in the method according to the invention. A coating layer thickness can be reliably determined even if the irradiation is oblique to the surface normal of a surface area. Advantageously, a coating layer thickness can be reliably determined for curved, coated substrates. Repositioning of a radiation source, a device for inductive heating and/or the detection device is not necessary.

It is expedient to inductively heat a substrate comprising an electrically conductive, in particular metallic, material and/or a layer comprising an electrically conductive, in particular metallic, material. Insofar as inductive heating is to take place, the layer or the substrate must comprise an electrically conductive material. It is also conceivable that heating takes place simultaneously or successively inductively and by irradiation or that some surface areas are heated by irradiation and others inductively.

In an embodiment of the invention, the apparatus according to the invention is integrated into an optical and/or mechanical coordinate measuring system. Advantageously, during a measurement of a component, in particular during a quality control, an additional, particularly simultaneous layer thickness determination can be carried out.

Coated substrates can be painted components such as vehicle exterior mirrors or bumpers for motor vehicles, or painted housings or painted protective covers for cell phones or laptop computers.

In a special embodiment of the process, the coated substrate is preheated before the beginning of irradiation and/or induction heating. Advantageously, the preheating enables a more precise and reliable determination of the coating thickness.

The substrate can be formed of different materials, for example a metallic, an organic and/or an inorganic material, in particular steel, aluminum or magnesium or a plastic such as polypropylene, polyurethane or silicone or a ceramic such as aluminum oxide or zirconium oxide.

In addition, the method according to the invention can be used to reliably determine a coating thickness on a particularly rough substrate, for example a sandblasted substrate.

Embodiments of the invention are to be explained in more detail below on the basis of examples with reference to the non-limiting figures:

### BRIEF DESCRIPTION OF THE DRAWINGS

FIG. 1 A first embodiment of a method according to the invention and an apparatus according to the invention, schematically represented, in a perspective view,

FIG. 2 a second embodiment of a schematically illustrated apparatus according to the invention in a perspective view,

FIG. 3 another embodiment of a schematically illustrated apparatus in a perspective view,

FIG. 4 a fourth embodiment of a schematically illustrated apparatus in a perspective view,

FIG. 5 a further embodiment of a schematically illustrated device in a perspective view,

FIG. 6A-6B a sixth embodiment of a schematically illustrated apparatus in a perspective view,

FIG. 7 a further embodiment of a schematically illustrated apparatus in a perspective view,

FIG. 8 a further embodiment of a schematically illustrated apparatus in a side view.

### DETAILED DESCRIPTION OF THE PREFERRED EMBODIMENTS

An apparatus (1) for determining a lacquer layer (3) applied to a cell phone protective shell (2), shown schematically in a perspective view in FIG. 1, comprises a radiation source (5) having a plurality of light-emitting diodes (LEDs) (4) in the IR range, whose irradiation cone (6), shown schematically with dashed lines, is provided for irradiating a lacquer surface (7) facing the light source (5). Although a pulse-like irradiation of the lacquer surface (7) is conceivable, periodic irradiation with a frequency of 200 Hz is preferred in this embodiment.

Furthermore, the apparatus (1) comprises a detection device (8), which is designed as a bolometer camera and which can detect the entire paint surface (7). A detection area (9) is represented by a double-dotted, single-dashed line and, in comprises the entire lacquer surface (7) in this embodiment. Each pixel of the bolometer camera (8) generates a measurement signal, i.e. a temperature profile over time in a single measurement point (10, 11, 12) on the lacquer surface (7). For reasons of clarity, FIGS. 1 to 6 each show three measuring points (10-12) as examples.

An evaluation device (13) uses the measurement signal to determine a thickness of the lacquer layer (3) applied to the cell phone protective shell (2) at the respective measurement point (10-12). For this purpose, calibration curves are stored in the evaluation device (13) which can be used to assign a coating thickness at the measuring point to a measurement signal for the respective measuring point (10-12).

Furthermore, the evaluation device (13) is connected to a screen (14) on which a single measured value or a coating thickness profile, i.e. a coating thickness distribution over several measuring points, can be displayed.

It is particularly advantageous if threshold values for a coating layer thickness are stored in the evaluation device (13) and the coating thickness profile is displayed in color, for example by displaying surface areas that are coated too thickly in yellow, those that are coated too thinly in red, and those that lie within a required coating thickness range in green. Advantageously, surface areas coated too thinly or too thickly can be quickly detected by an operator of the apparatus (1).

Although the detection device (8) in this embodiment is designed as a bolometer camera, it is conceivable to design it as an IR camera or other sensor array for detecting thermal radiation.

Although it is furthermore conceivable that the device (1) is movable in three dimensions, in this and the following embodiments it is movable in two dimensions in the direction of arrows (15, 16) vertically and horizontally, with a distance to the surface areas preferably being constantly 10 cm.

It is also conceivable that an assembly comprising a radiation source (5), detection device (8) and/or evaluation device (13) is arranged in a stationary manner and a cell phone protective shell (2) is moved past to determine a lacquer layer thickness. This can be done either manually by an operator of the apparatus or mechanically.

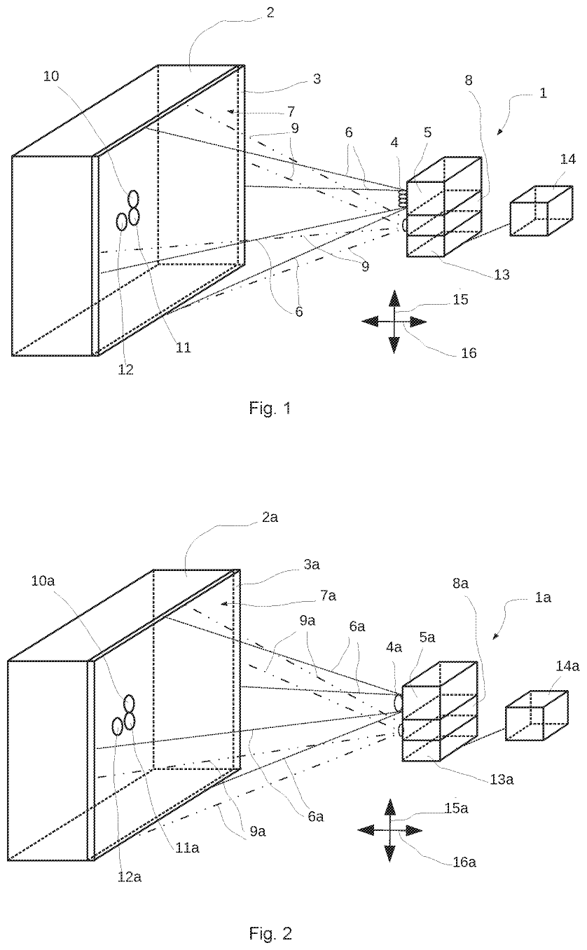

Reference is now made to FIG. 2, where identical or equal-acting parts are designated with the same reference number as in FIG. 1 and the letter a is added to the respective reference number.

An apparatus (1a) schematically shown in FIG. 2 comprises a radiation source (5a) having a superluminescent light-emitting diode (4a), which is provided for pulse-like or periodic irradiation of a lacquer surface (7a) with light of a wavelength range of 500 to 800 nm at a frequency of 150 Hz.

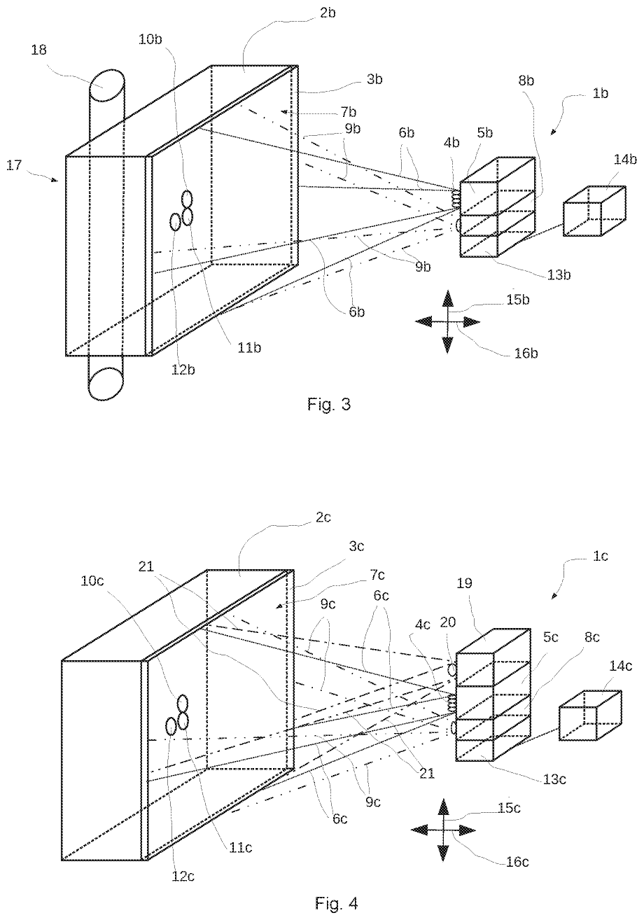

Reference is now made to FIG. 3, where identical or equal-acting parts are designated with the same reference number as in FIGS. 1 and 2, and the letter b is added to the respective reference number.

An apparatus (1b) shown in a schematic view in FIG. 3 is provided for determining the thickness of a powder coating (3b) applied to a metallic component (2b). In this example, heating of a coating surface (7b) is performed by irradiation with a radiation source (5b) and inductively by an induction device (18) mounted on a side (17) of the component (2b) facing away from a detection device (8b). In this embodiment, the detection device (8b) is designed as a bolometer camera that can detect a powder coating surface (7b). An exclusively inductive heating of the coating surface (7b) is conceivable.

Reference is now made to FIG. 4, where identical or equal-acting parts are designated with the same reference number as in FIGS. 1, 2 and 3, and the letter c is added to the respective reference number.

An apparatus (1c) shown in FIG. 4 differs from those shown in FIGS. 1 to 3 in that two radiation sources (5c, 19) different from each other are provided to irradiate a lacquer surface (7c). In this embodiment, a first radiation source (5c) comprises a plurality of blue light-emitting diodes (4c), and a second radiation source (19) comprises a thermal radiator (20) having an irradiation cone (21) that irradiates the entire lacquer surface (7c).

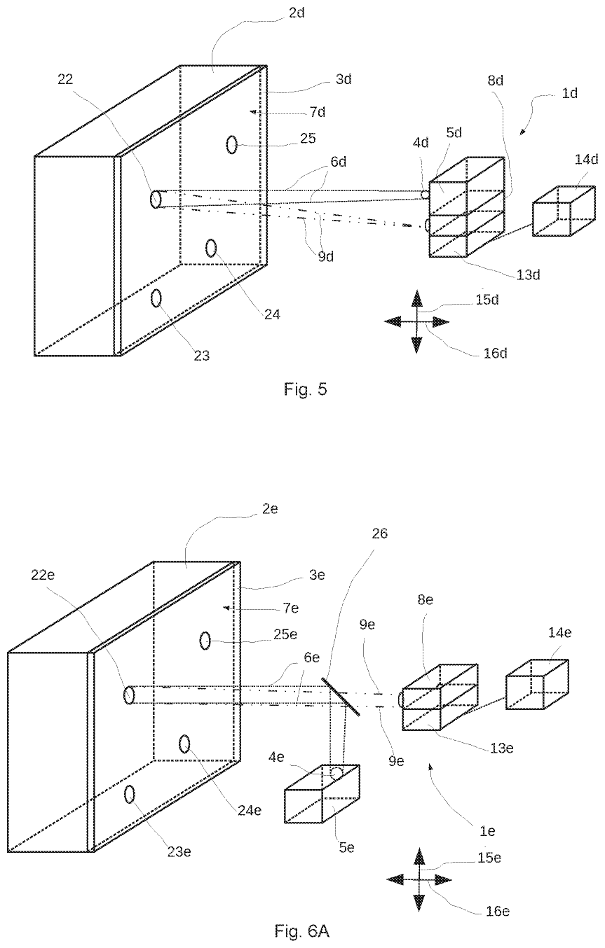

Reference is now made to FIG. 5, where identical or equal-acting parts are designated with the same reference number as in FIGS. 1 to 4, and the letter d is added to the respective reference number.

An apparatus (1d) for determining a coating thickness of a coating (3d) shown in FIG. 5 differs from those shown in FIGS. 1 to 4 in that not the entire coating surface (7d) is irradiated, but individual, discrete surface areas (22, 23, 24, 25). The surface areas (22-25) are successively irradiated by a laser (4d) of a radiation source (5d) once or periodically for heating, and emitted thermal radiation is detected by a detection device (8d). Although a size of an excitation spot, i.e. a diameter of a laser beam irradiating the surface (7d) in the respective surface area (22-25), corresponds to the size of the preferably round irradiated surface area (22-25), it is conceivable that a measurement spot is smaller than the excitation spot. An evaluation device (13d) determines the layer thickness of the coating (3d) for each individual surface area (22-25) and can either display thickness values on a display screen (14d) or determine and display a layer thickness profile of the coating surface (7d) by interpolation and extrapolation of the layer thickness values of the surface areas (22-25).

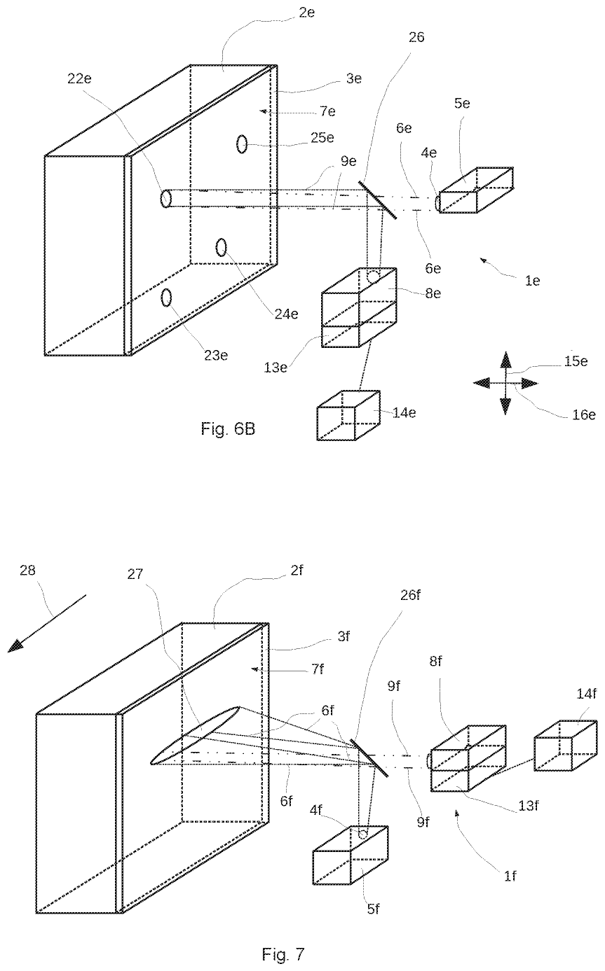

Reference is now made to FIG. 6, where identical or equal-acting parts are designated with the same reference number as in FIGS. 1 to 5, and the letter e is added to the respective reference number.

An apparatus (1e) shown in FIG. 6a differs from those shown in FIGS. 1 to 5 in that a beam path of a radiation source (5e) and that of a detection device (8e) are parallel in sections. For this purpose, the radiation source (5e) for irradiating a surface (7e) and a detection device (8e) are arranged perpendicular to each other. Light from the radiation source (5e) is deflected by a dichroic beam splitter (26) in the direction of a surface (7e), while thermal radiation emitted by heating the surface (7e) can pass through the beam splitter (26) in the direction of the detection device (8e). Advantageously, this embodiment enables accurate determination of the layer thickness regardless of a distance between the radiation source (5e) and the surface (7e). Although in this embodiment a determination of the layer thickness takes place in certain surface areas (22e-25e), it is conceivable that the entire surface (7e) is irradiated.

In addition, it is conceivable that a beam splitter (26) shown in FIG. 6b is designed as a perforated mirror in which light from a radiation source passes through a hole in the perforated mirror and emitted thermal radiation is deflected by a reflective part of the perforated mirror in the direction of a detection device. A hole mirror is particularly advantageous when a laser or a radiation source with high spatial coherence such as a superluminescent diode is used as the radiation source (5e).

Reference is now made to FIG. 7, where identical or equal-acting parts are designated with the same reference number as in FIGS. 1 to 6, and the letter f is added to the respective reference number.

An apparatus (1f) shown in FIG. 7 differs from those shown in FIGS. 1 to 6 in that the apparatus (1f) is set up to determine a layer thickness of a coated coil (2f).

A radiation source (5f) irradiates—pulse-like or periodically modulated—a narrow surface area (27) of the coated coil (2f) moving past the apparatus (1f) in the direction of an arrow (28) extending parallel to a direction of movement of the coil (2f). A conveying means not shown in FIG. 7, which can comprise a reel, for example, can be provided for moving the coil (2f).

A stationary detection device (8f) detects radiated heat of the narrow, moving surface area (27) and determines an average layer thickness from several determined layer thicknesses by averaging.

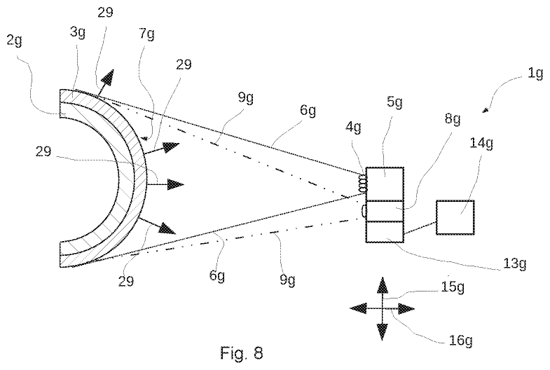

Reference is now made to FIG. 8, where identical or equal-acting parts are designated with the same reference number as in FIGS. 1 to 7, and the letter g is added to the respective reference number.

An apparatus (1g) shown in a side view in FIG. 8 differs from those shown in FIGS. 1 to 7 in that a radiation source (5g) is provided to form an irradiation cone (6g) whose rays irradiate a coating surface (7g) obliquely to a normal (29). Since a time delay with which thermal radiation is emitted is independent of an angle of incidence of excitation radiation of a radiation source on a coating surface (7g), perpendicular incidence of rays of the irradiation cone (6g) is not required for determining a coating thickness. Advantageously, the method according to the invention can be used to determine a coating thickness on curved, coated substrates such as car body attachments, laptop housings, cell phone housings or cell phone protective covers without repetitive realignment of the radiation source (5g), a device for inductive heating and/or the detection device (8g).

It is conceivable that an apparatus (1-1g) is movable and preferably attached to an industrial robot. This allows several surface areas (7; 7a; 7b; 7c; 22-25; 22e-25e; 27; 7g) to be detected in succession in an automated manner.

It is also conceivable that an optical system, which may comprise a lens for example, is introduced into a beam path formed by an irradiation cone (6-g).

Furthermore, a surface area (22-25; 22e-25e; 27) heated inductively or by irradiation may have a smaller size than a size of the irradiation cone (6-g) incident on the surface (7; 7a; 7b; 7c; 7g), or may be at most the same size.

1. A method for determining a layer thickness of a layer applied to a substrate, in particular a coating layer, in which at least one surface area of the coated substrate is heated by irradiation with at least one radiation source and/or inductively heated, and thermal radiation emitted from the at least one surface area is detected by a detection device (8-8g),
characterized in that
the layer thickness is determined based on the emitted thermal radiation.

2. The method according to claim 1,
characterized in that
the at least one surface area is irradiated with a monochromatic and/or coherent radiation source or with electromagnetic radiation of a certain wavelength range, preferably between 200 nm and 15 μm, in particular between 200 and 750 nm, between 800 and 3500 nm or between 4 and 13 μm.

3. The method according to claim 1,
characterized in that
the at least one surface area is irradiated with several identical or different radiation sources.

4. The method according to claim 1,
characterized in
in that the at least one surface area is irradiated with a plurality of radiation sources, each of which is designed to generate electromagnetic radiation of a specific wavelength range or a specific wavelength.

5. The method according to claim 1,
characterized in that
the irradiation of the at least one surface area is periodically modulated, in particular with a frequency between 0.01 and 2000 Hz, preferably between 20 to 800 Hz.

6. The method according to claim 1,
characterized in
that several, preferably adjacent surface areas are successively irradiated by the at least one radiation source, and by means of an evaluation device, a preferably graphically displayable layer thickness profile of a surface to be measured is established.

7. The method according to claim 1,
characterized in that
the at least one surface area has a size, in particular a diameter, between 0.2 μm and 200 cm, preferably between 1 and 20 μm or between 0.2 and 2 cm.

8. The method according to claim 1,
characterized in that
the at least one surface area is oblique or parallel to a surface normal.

9. The method according to claim 1,
characterized in that
the coated substrate is preheated before the beginning of irradiation and/or induction heating.

10. An apparatus for determining a layer thickness of a layer applied to a substrate, in particular a coating layer,
characterized in that
the device comprises at least one radiation source for heating at least one surface area by irradiation and/or a device for inductively heating the at least one surface area, at least one detection device for detecting thermal radiation emitted from the at least one surface area, and an evaluation device for determining a layer thickness.

11. The apparatus according to claim 10,
characterized in that
the substrate and/or the layer is/are formed from an electrically conductive, in particular metallic, material and/or comprise an electrically conductive, in particular metallic, material and can be inductively heated.

12. The apparatus according to claim 10,
characterized in that
the at least one radiation source comprises at least one superluminescent diode, at least one light-emitting diode (LED), at least one polariton laser, at least one thermal radiator and/or at least one quantum cascade laser, and in particular is/are arranged for periodically irradiating the at least one surface area.

13. The apparatus according to claim 10,
characterized in that
the detection device comprises an IR camera or/and a bolometer camera.

14. The apparatus according to claim 10,
characterized in that
the detection device is designed for simultaneous or successive detection of several surface areas.

15. The apparatus according to claim 10,
characterized in that
the at least one radiation source, the device for inductive heating and/or the detection device are movably and is or are arranged to be passed by a plurality of, in particular adjacent surface areas.

16. The apparatus according to claim 10,
characterized in that
the at least one radiation source, the means for inductive heating and/or the detection device is or are arranged in a stationary manner and a conveying means is provided, which is arranged to guide the coated substrate with the surface areas to be heated past the radiation source, the device for inductive heating and/or the detection device in such way that a heating and a detection of radiation emitted from the at least one surface area can take place.
